(19) United States
(12) Patent Application Publication
(10) Pub. No.: US 2007/0028734 A1
(43) Pub. Date: Feb. 8, 2007

(54) Cutting apparatus equipped with blade detection means

(75) Inventor: Kazuma Sekiya, Tokyo (JP)

Correspondence Address: SMITH, GAMBRELL & RUSSELL, 1850 M STREET, N.W., SUITE 800, WASHINGTON, DC, 20036, US

(73) Assignee: Disco Corporation

(21) Appl. No.: 11/493,621

(22) Filed: Jul. 27, 2006

(30) Foreign Application Priority Data
Aug. 3, 2005 (JP) 2005-225172

(51) Int. Cl. B26D 5/20; B26D 5/00

(52) U.S. Cl. 83/72; 83/76.9; 83/522.11; 700/180

(57) ABSTRACT

A cutting apparatus having a cutting blade is designed for reliable recognition of a state, such as chipping or wear, occurring in the cutting blade. The cutting apparatus at least includes cutting means having the cutting blade for cutting a workpiece held on a chuck table while supplying a cutting fluid to the workpiece, and blade detection means for detecting the state of the cutting blade. The blade detection means at least includes an imaging section for imaging an outer peripheral edge portion of the cutting blade, a light emitting section confronting the imaging section and disposed at a position facing the outer peripheral edge portion of the cutting blade, an image processing section for processing an image obtained by the imaging section, and a blinking control section for blinking the light emitting section. Since the light emitting section confronts the imaging section, contrast between a portion in the obtained image blocked by the cutting blade and a portion not blocked thereby becomes distinct.

### BACKGROUND OF THE INVENTION AND RELATED ART STATEMENT

1. Field of the Invention

This invention relates to a cutting apparatus equipped with a cutting blade. More particularly, the invention relates to a cutting apparatus having the function of detecting the state of a cutting blade, such as chipping or wear.

2. Description of Related Art

A wafer having a plurality of devices, such as IC and LSI, formed therein is cut longitudinally and laterally at its cutting lines arranged in a lattice pattern (the cutting lines are generally called streets) with the use of a cutting blade rotating at a high speed. As a result, the wafer is divided into individual chips, and used for various types of electronic equipment.

The cutting blade is mounted on a spindle, which can be rotated at a high speed, and is used. A cutting edge portion is formed on the outer periphery of the cutting blade. The cutting edge portion is composed of abrasive grains comprising diamond or the like, the abrasive grains being compacted by electrocasting, metal bonding, or resin bonding. Thus, the cutting edge portion poses the problem that upon cutting, it deteriorates over time to undergo chipping or wear, thereby lowering the quality of the individual devices formed by cutting.

To solve the above-mentioned problem, the applicant developed an apparatus which images the outer peripheral edge portion of the cutting edge portion constituting the cutting blade to check its shape, and can replace the cutting blade immediately if impermissible chipping or the like is detected (see Japanese Patent 2,627,913). In such an apparatus, light is thrown from a light emission source onto the cutting blade, and its reflected light is imaged.

### OBJECTS AND SUMMARY OF THE INVENTION

During cutting by the cutting blade, however, cutting water needs to be supplied to the site of contact between the cutting blade and a workpiece. With the configuration in which the cutting blade is irradiated with light and reflected light is imaged, the reflected light may be scattered by splashes of cutting water sprinkled during high speed rotation of the cutting blade, so that the cutting blade may fail to be recognized based on the resulting image. This has made it sometimes impossible to detect chipping or wear of the cutting blade.

It is an object of the present invention, therefore, to permit imaging for reliable recognition of the cutting blade so that a state, such as chipping or wear, occurring in the cutting blade can be detected reliably.

According to the present invention, there is provided a cutting apparatus at least including a chuck table for holding a workpiece, a cutting means having a cutting blade for cutting the workpiece held on the chuck table while supplying a cutting fluid to the workpiece, and a blade detection means for detecting the state of a cutting edge portion of the cutting blade, wherein the blade detection means is composed at least of a light emitting section disposed at a position facing an outer peripheral edge portion of the cutting edge portion of the cutting blade, an imaging section confronting the light emitting section for imaging the outer peripheral edge portion of the cutting edge portion of the cutting blade by transmitted light thrown by the light emitting section, an image processing section for processing an image obtained by the imaging section, and a blinking control section for blinking the light emitting section.

The blade detection means is preferably equipped with a display section for displaying an image binary-processed by the image processing section. By so doing, an operator can see the display section to check the state of chipping caused to the cutting blade.

Preferably, the blinking control section determines the necessary number of images, K, for imaging the entire periphery of the outer peripheral edge portion of the cutting edge portion of the cutting blade, by the following equation
K≧πD/W
where D [mm] is the diameter of the cutting edge portion of the cutting blade, and W [mm] is the circumferential length of the outer peripheral edge portion of the cutting edge portion of the cutting blade in one image obtained by the imaging section, and

determines the timing T of causing light emission of the light emitting section by the following equation
T[seconds]={60[seconds]/M}N+{60 [seconds]/(MK)}n
where M [rpm] is the rotational speed of the cutting blade, provided that each of N and n is increased from 0 up to an arbitrary positive integer. n can be changed from 0 up to K. By determining T, there can be provided timing for obtaining the images based on which the entire region of the outer peripheral edge portion of the cutting edge portion of the cutting blade can be clearly recognized. By rendering N and n variables to set them flexibly, the timing of imaging can be adjusted as appropriate.

The blade detection means is preferably furnished with a determination section for determining whether the magnitude of chipping of the cutting edge portion of the cutting blade exceeds an allowable value.

### BRIEF DESCRIPTION OF THE DRAWINGS

FIG. 1 is an explanation drawing showing the configuration of blade detection means.

### DETAILED DESCRIPTION OF PREFERRED EMBODIMENTS

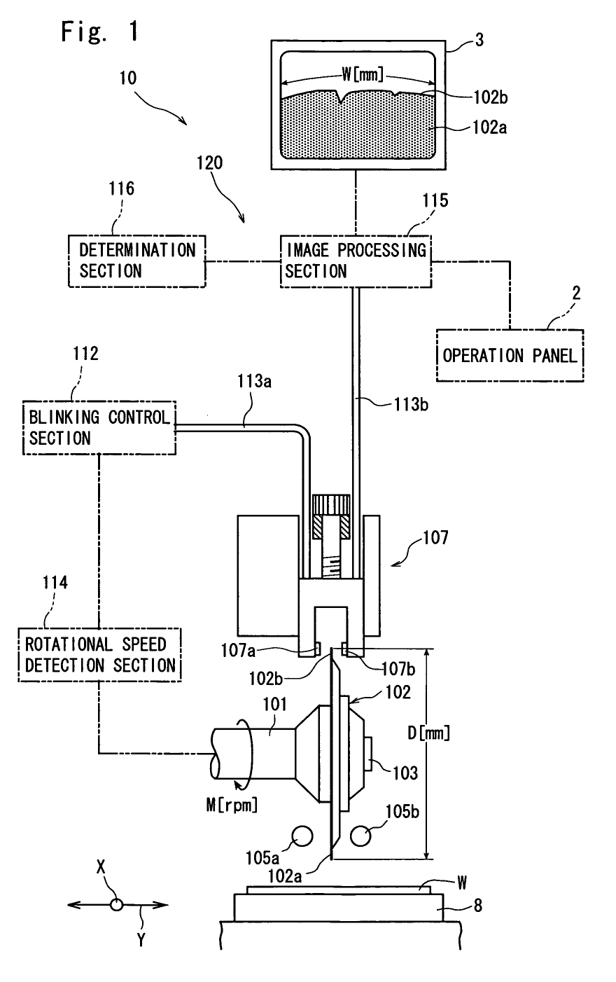

FIG. 1 shows a cutting means (cutting apparatus) 10 for cutting a workpiece to divide it into individual chips, and a blade detection device 120 provided in the cutting apparatus.

An example of the workpiece to be cut by the cutting apparatus is a wafer W having a plurality of devices formed therein. In cutting the wafer W, the wafer W is stuck to a tape disposed on a frame (not shown), and the wafer W is supported by a chuck table 8.

The chuck table 8 is configured to be movable in an X-axis direction (perpendicular to the sheet face of FIG. 1) and rotatable in a circumferential direction. An alignment means (not shown) for imaging the wafer by a wafer imaging section to detect a region to be cut is disposed above the moving path of the chuck table 8 in the X-axis direction. The wafer W held on the chuck table 8 is moved to a site directly below the wafer imaging section (not shown) by the movement of the chuck table 8 in the X-axis direction, and the face of the wafer W is imaged at the site, whereupon its region to be cut is detected by the alignment means. Then, the chuck table 8 is further moved in the X-axis direction, and the wafer W is subjected to the action of the cutting means 10.

In the cutting means 10, a cutting blade 102 is mounted on a front end portion of a spindle 101 rotatably supported by the cutting apparatus, and is fixed by a nut 103. A cutting edge portion 102a is secured to an outer peripheral edge portion of the cutting blade 102. The cutting edge portion 102a is composed of abrasive grains comprising diamond or the like, the abrasive grains being compacted by electrocasting, metal bonding, or resin bonding.

Cutting water nozzles 105a, 105b for ejecting cutting water toward the site of contact between the cutting edge portion 102a of the cutting blade 102 and the wafer W are provided at the lower height position of the cutting blade 102. A supply means (not shown) for cutting water is connected to the cutting water nozzles 105a, 105b, and the cutting water nozzles 105a and 105b are disposed to sandwich the cutting edge portion 102a of the cutting blade 102 from the front side and the rear side. A blade detection means 120 for detecting the state of the cutting edge portion 102a is provided beside the upper end of the cutting blade 102. The blade detection means 120 is furnished at least with a light emitting section 107a, an imaging section 107b, and a blinking control section 112 and an image processing section 115 (to be described later).

First, the cutting of the wafer W will be described. After the region of the wafer W to be cut is detected by the alignment means, the cutting means 10 is lowered, accompanied by the high speed rotation of the cutting blade 102, with the wafer W being moved in the X-axis direction along with the chuck table 8. As a result, the cutting edge portion 102a of the cutting blade 102 cuts into the region of the wafer W to be cut, performing cutting. During cutting, cutting water is supplied from the cutting water nozzles 105a, 105b to the wafer W. Moreover, the cutting means 10 is indexed in a Y-axis direction, while the wafer W is reciprocated in the X-axis direction. Further, the chuck table 8 is rotated through 90 degrees, and then similar cutting is performed, whereby the wafer W is cut longitudinally and laterally to be divided into individual devices.

A blade imaging member 107 is furnished with the light emitting section 107a and the imaging section 107b. The light emitting section 107a and the imaging section 107b confront each other, an outer peripheral edge portion 102b of the cutting edge portion 102a constituting the cutting blade 102 is located between the light emitting section 107a and the imaging section 107b, and the cutting edge portion 102a of the cutting blade 102 blocks the space between the light emitting section 107a and the imaging section 107b. In other words, the light emitting section 107a and the imaging section 107b face the cutting edge portion 102a of the cutting blade 102.

The blinking control section 112 is connected to the light emitting section 107a to blink the light emitting section 107a with a timing set by the blinking control section 112, and the light emitting section 107a functions as a flash at the time of imaging by the imaging section 107b. In the illustrated example, the light emitting section 107a and the blinking control section 112 are connected by an optical fiber 113a. During cutting of the wafer, the light emitting section 107a emits light periodically, and the imaging section 107b images a region including the outer peripheral edge portion 102b of the cutting edge portion 102a with the timing of light emission by the light emitting section 107a. The light thrown by the light emitting section 107a toward the cutting edge portion 102a is blocked at a site, where the cutting edge portion 102a exists, is thus turned into a shadow and does not reach the imaging section 107b. On the other hand, the thrown light is transmitted at a site, where the cutting edge portion 102a does not exist, and is thus brought to the imaging section 107b. In the image thus obtained through light emission by the light emitting section during imaging, a sharp contrast is provided between the portion of the light blocked by the cutting blade 102 and the portion of the light not blocked by the cutting blade 102. Even in the presence of splashes of cutting water sprinkled, therefore, binary processing can yield an image from which the outer peripheral edge portion 102b of the cutting blade 102 can be clearly recognized.

The blinking control section 112 is connected to a rotational speed detection section 114 for detecting the rotational speed of the spindle 101, namely, the rotational speed of the cutting blade 102. Based on information on the rotational speed of the spindle 101 transferred from the rotational speed detection section 114, the blinking control section 112 computes the light emission timing of the light emitting section 107a. Concretely, the blinking control section 112 performs the following processing:

As shown in the drawing, the diameter of the cutting blade 102, which has been inputted by an operator from an operation panel 2 and stored into a memory, etc. beforehand, is designated as D [mm], and the rotational speed of the cutting blade 102 detected by the rotational speed detection section 114 is designated as M [rpm]. The circumferential length of the outer peripheral edge portion 102b of the cutting blade 102 reflected in the image obtained by single imaging by the imaging section 107b is designated as W [mm]. In the blinking control section 112, these values are substituted into the following equation (1) to determine the necessary number of images, K, for imaging the entire region of the outer peripheral edge portion 102b:
K≧πD/W (1)

As noted above, the number K of images has a value calculated by dividing the circumference (πD) of the cutting blade 102 by the circumferential length (W), or a higher value.

Furthermore, the blinking control section 112 determines the timing T, with which the light emitting section 107a is allowed to emit light, from the following equation (2):
T[seconds]={60[seconds]/M}N+{60 [seconds]/(MK)}n (2)

When the origin in the rotation of the cutting blade 102 (i.e., the position where the rotation angle is 0 degree) is set, the first term {60[seconds]/M}N in the equation (2) represents the timing with which the cutting blade 102 is located at its origin. N in this term refers to a variable which increases from 0 up to an arbitrary positive integer.

On the other hand, the second term {60 [seconds]/(MK)}n in the equation (2) represents the timing with which the cutting blade 102 is located at a position displaced from the above origin. The symbol n denotes the timing of switching to a next image in connection with the number of images, K. Here, n is increased from 0 up to K (positive integer) determined by the equation (1), for example, by one at a time.

For example, if n is increased from 0 up to K during the period where N=0, imaging is performed K times during one rotation of the cutting blade 102 at N=0, whereby the entire region of the outer peripheral edge portion 102b of the cutting blade 102 can be imaged. Then, the value of N is increased like N=1, N=2, N=3, and so on. Every time the value of N increases by 1, the rotational speed (i.e., the number of revolutions) of the cutting blade 102 increases by one rotation. During one rotation of the cutting blade 102, the value of n is increased like n=1, n=2, . . . , n=K. By so doing, whenever the cutting blade 102 makes one rotation, the adjacent regions are imaged one after another. In this manner, imaging is carried out K times, so that the entire region of the outer peripheral edge portion 102b of the cutting blade 102 can be always imaged. Since N and n are variables, the timing of imaging can be adjusted, as appropriate, by flexibly setting these variables. If the value of N is rendered only an odd number or an even number, for example, the entire region of the outer peripheral edge portion 102 is imaged during alternate rotations. If n is set at a specific value, only a specific region of the outer peripheral edge portion 102b can continue to be imaged.

The points in time when the light emitting section 107a is allowed to emit light are determined by the above-mentioned equations (1) and (2). According to these determinations, imaging by the imaging section 107b is carried out, for example, simultaneously with the time points of light emission by the light emitting section 107a under the control of the blinking control section 112. By this procedure, it becomes possible to obtain images from which the entire region of the outer peripheral edge portion 102b of the cutting blade 102 can be clearly recognized. Thus, chipping or wear of the cutting blade 102 can be detected without fail.

The imaging section 107b is connected to the image processing section 115, and an image obtained by the imaging section 107b with the timing of light emission by the light emitting section 107a is transferred to the image processing section 115.

The image processing section 115, optionally, transfers the obtained image to a display section 3 for display of the image, and applies binary processing to the image. According to the binary processing, a certain threshold value is set for the brightness of light inputted by the imaging section 107b, and a portion brighter than the brightness of the threshold value is rewritten, for example, as white, while a portion darker than the brightness of the threshold value is rewritten, for example, as black.

In the image displayed on the display section 3, the contrast between a portion blocked by the cutting edge portion 102a of the cutting blade 102 and a portion not blocked thereby becomes distinct. Even in the presence of splashes of cutting water sprinkled, therefore, the operator can clearly recognize the outer peripheral edge portion 102b of the cutting blade 102. In this case, the display section 3 constitutes a constituent element of the blade detection means 120.

The image binary-processed or binarized by the image processing section 115 is transferred to a determination section 116 having CPU and a memory. The determination section 116 determines the magnitude of chipping or the degree of wear of the cutting edge portion 102a of the cutting blade 102 to decide whether the chipping exceeds an allowable value, or whether the wear falls within a tolerance range. Concretely, the determination section 116 performs the following processing:

In the determination section 116, the area accounted for by the cutting blade 102 of the binarized image is calculated based on the number of pixels, and stored into the memory. This processing may be performed for all the images obtained by imaging, or for only some images extracted. Particularly when chipping occurred in the cutting blade 102, it is preferred to extract the image of the chipped portion and check the state of. chipping.

If chipping of the cutting edge portion 102a of the cutting blade 102 is to be detected, the values of all areas are compared for the obtained images of the same portion of the cutting edge portion 102a of the cutting blade 102, the maximum value and the minimum value are found from these values, and the difference between the maximum value and the minimum value is calculated. The value of this difference represents the magnitude of the chipping occurring in the outer peripheral edge portion 102b of the cutting edge portion 102a. That is, if there is no chipping, the difference between the maximum value and the minimum value is zero.

Then, a determination is made as to whether the found difference is not larger than a predetermined allowable value. The predetermined allowable value can be inputted from the operation panel 2 shown in FIG. 1, and stored into the memory. If the difference between the maximum value and the minimum value is not larger than the allowable value, the determination section 116 determines that there is no chipping, or that chipping, if any, does not harm cutting, and cutting is continued unchanged. If the difference between the maximum value and the minimum value exceeds the allowable value, on the other hand, cutting, if continued unchanged, is liable to deteriorate the quality of the devices. Thus, the determination section 116 informs the operator to this effect. The method of informing is to sound, display on the display section 3, or the like. The informed operator interrupts cutting, and replaces the cutting blade by a new one, thereby avoiding the formation of low quality devices. As noted here, the determination section 116 can also serve as a constituent element of the blade detection means 120.

If wear of the outer peripheral edge portion 102b of the cutting edge portion 102a constituting the cutting blade 102 is to be detected, an outer peripheral edge portion of a cutting blade without wear is, in advance, imaged and binarized, and the area accounted for by the cutting blade of the binarized image is stored into the memory. The difference between this area and the area accounted for by the cutting blade 102 of a binarized image produced by binarizing an image obtained by actual imaging is calculated. If this difference is less than the allowable value inputted and stored into the memory beforehand, a determination is made that the wear falls within the tolerance range. If the difference is not smaller than the allowable value stored into the memory, a determination is made that the wear exceeds the tolerance range, and the operator is informed of this fact. The informed operator interrupts cutting, and replaces the cutting blade by a new one, thereby avoiding the formation of low quality devices.

According to the present invention, the light emitting section and the imaging section are arranged to confront each other, and the light emitting section is disposed at the position facing the outer peripheral edge portion of the cutting blade. In the image obtained by light emission of the light emitting section during imaging, therefore, the contrast between the portion blocked by the cutting blade and the portion not blocked thereby becomes distinct. Even in the presence of splashes of cutting water sprinkled, it is possible to obtain an image which enables the outer peripheral edge portion of the cutting blade to be clearly recognized.

When the determination section, which determines whether the magnitude of chipping of the cutting edge portion of the cutting blade exceeds the allowable value, is provided in the blade detection means, the operator can be immediately informed if chipping exceeds the allowable value. In response, the cutting blade can be immediately replaced.

According to the present invention, as described above, transmitted light thrown by the light emitting section 107a is blocked, as long as the cutting blade 102 exists between the light emitting section 107a and the imaging section 107b, even if cutting water adheres to the outer peripheral edge portion 102b of the cutting blade 102. Thus, the shape of the outer peripheral edge portion 102b of the cutting blade 102 can be detected more accurately. That is, whether or not the transmitted light passes the cutting blade 102 is determined. This can prevent a detection error due to diffuse reflection of light which is caused by adhesion of cutting water to the cutting blade 102 as in the past.
T[seconds]={60[seconds]/M}N+{60 [seconds] /(MK)}n

Since the above equation is used, storage of images into the memory makes it possible to retrieve the image of the cutting blade 102 immediately after completion of operation. Moreover, the image is not a moving image, but is substantially a sequence image resulting from a still image. Hence, memory capacity can be markedly decreased in comparison with the moving image, and long-term observation can be made.

While the preferred embodiments of the present invention have been described in detail by reference to the accompanying drawings, it is to be understood that the invention is not limited to such embodiments, but various changes and modifications may be made without departing from the scope of the appended claims.

1. A cutting apparatus equipped with blade detection means, at least including a chuck table for holding a workpiece, cutting means having a cutting blade for cutting the workpiece held on the chuck table while supplying a cutting fluid to the workpiece, and the blade detection means for detecting a state of a cutting edge portion of the cutting blade, wherein
the blade detection means is composed at least of a light emitting section disposed at a position facing an outer peripheral edge portion of the cutting edge portion of the cutting blade, an imaging section confronting the light emitting section for imaging the outer peripheral edge portion of the cutting edge portion of the cutting blade by transmitted light thrown by the light emitting section, an image processing section for processing an image obtained by the imaging section, and a blinking control section for blinking the light emitting section.

2. The cutting apparatus equipped with blade detection means according to claim 1, wherein the blade detection means is equipped with a display section for displaying an image binary-processed by the image processing section.

3. The cutting apparatus equipped with blade detection means according to claim 1, wherein the blinking control section
determines a necessary number of images, K, for imaging an entire periphery of the outer peripheral edge portion of the cutting edge portion of the cutting blade, by the following equation
K≧πD/W
where D [mm] is a diameter of the cutting edge portion of the cutting blade, and W [mm] is a circumferential length of the outer peripheral edge portion of the cutting edge portion of the cutting blade in one image obtained by the imaging section, and
determines a timing T of causing light emission of the light emitting section by the following equation
T[seconds]={60[seconds]/M}N+{60 [seconds] /(MK)}n
where M [rpm] is a rotational speed of the cutting blade, provided that each of N and n is increased from 0 up to an arbitrary positive integer.

4. The cutting apparatus equipped with blade detection means according to claim 3, wherein n can be changed from 0 up to K.

5. The cutting apparatus equipped with blade detection means according to claim 1, wherein the blade detection means is furnished with a determination section for determining whether a magnitude of chipping of the cutting edge portion of the cutting blade exceeds an allowable value.
